(19) United States
(12) Patent Application Publication
(10) Pub. No.: US 2022/0291142 A1
(43) Pub. Date: Sep. 15, 2022

(54) CHARACTERIZATION OF HIGH-SPEED ELECTRO-OPTIC DEVICES WITHOUT OPTICAL COUPLERS OR INTEGRATED DETECTORS

(71) Applicants: The Regents of the University of California, Oakland, CA (US); California Institute of Technology, Pasadena, CA (US)

(72) Inventors: Shayan Mookherjea, San Diego, CA (US); Xiaoxi Wang, San Diego, CA (US); Boris A. Korzh, Altadena, CA (US); Matthew D. Shaw, Los Angeles, CA (US)

(21) Appl. No.: 17/654,561

(22) Filed: Mar. 11, 2022

Related U.S. Application Data
(60) Provisional application No. 63/159,963, filed on Mar. 11, 2021.

(51) Int. Cl. G01N 21/95

(52) U.S. Cl. CPC G01N 21/9505; G01N 21/9503

(57) ABSTRACT

Methods, systems, and devices for testing an electro-optic device such as a modulator or a switch are disclosed. In one implementation, an apparatus includes an optical source to generate light, a first light transmission structure to route the light into the electro-optic device through a first guide segment structured to guide optical waves and optically couplable to the electro-optic device, an electrical probe to apply one or more electrical modulation signals to the electro-optic device to generate modulated light by modulating the light routed into the electro-optic device, a second light transmission structure to collect at least part of the modulated light from a second guide segment structured to guide optical waves and optically couplable to the electro-optic device, a detector to generate an electrical output signal corresponding to the collected light, and a signal processing device to record times at which each photon corresponding to the collected light is detected by processing the electrical output signal.

### PRIORITY CLAIM AND CROSS-REFERENCE TO RELATED APPLICATIONS

This patent document claims the priority and benefits of U.S. Provisional Application No. 63/159,963, titled “CHARACTERIZATION OF HIGH-SPEED ELECTRO-OPTIC DEVICES WITHOUT OPTICAL COUPLERS OR INTEGRATED DETECTORS” filed on Mar. 11, 2021. The entire content of the aforementioned patent application is incorporated by reference as part of the disclosure of this patent document.

### STATEMENT REGARDING FEDERALLY SPONSORED RESEARCH OR DEVELOPMENT

This invention was made with government support under CNS1525090 and EFMA1640968 awarded by the National Science Foundation and under NNX16AD14G and 80NMO0018D0004 awarded by National Aeronautics and Space Administration. The government has certain rights in the invention.

### TECHNICAL FIELD

This patent document relates to measuring properties of electro-optic devices.

### BACKGROUND

A modern silicon photonic wafer may contain hundreds or thousands of high-speed electro-optic devices, such as Mach-Zehnder modulators (MZM), electro-absorption modulators, switches, phased-array structures, etc. Devices operating near their performance limits routinely show variability in precise radio frequency (RF)-optical index matching or in the termination impedance, as well as low extinction ratio, which makes their high-frequency behavior not predictable from DC or low-frequency measurements alone. Singulating wafers into dies and performing careful fiber alignment on each device that is necessary in order to collect enough light to measure high-speed eye diagrams, for example, is among the most slow and costly processes in integrated photonics manufacturing. Optical input/output test ports (e.g., couplers, tap power splitters, metal probing pads, etc.) may be fabricated, but their inclusion leads to increased loss, added noise and poor scaling, and sometimes, added fabrication complexity. Alternative methods for stand-off testing include fabricating metal pads onto the optical circuit, or metal gratings fabricated onto fiber probe facets, but have only yielded direct current (DC) or low frequency (sub-MHz) data, even when in contact with the waveguide.

### SUMMARY

The technology disclosed in this patent document can be implemented in some embodiments to observe, without intentionally-defined optical coupling structures or integrated photodetectors, the operation of an electro-optic device such as a modulator or a switch which is operated at high speed.

The technology disclosed can be implemented in some embodiments to provide a method for characterizing electro-optic devices while shining light onto a waveguide before the device and collecting scattered light from a waveguide after the device while applying electronic test signals to it. High speed characterization can be performed even though the average optical power levels of the detected modulated light may be extremely weak (e.g., in the nanowatts to femtowatts range).

The technology disclosed can also be implemented in some embodiments to enable testing high-speed modulator devices before singulation, separation from the wafer or photonic circuit, and/or packaging, which may be costly and time consuming. Rapidly acquiring detailed knowledge of the actual performance of each high-speed device in a wafer without access ports or test structures or integrated detectors, and to do so at full operational speed will benefit integrated photonics technology by improving yield and driving down costs.

In some implementations of the disclosed technology, photonic circuits include integrated photodetectors to monitor bias points, temperature drifts, polarization drifts, or other quasi-static or slowly-varying signals. The technology disclosed can be implemented in some embodiments to enable testing high-speed modulator devices without inclusion of integrated high-speed photodetectors, which are more costly to fabricate, or difficult to operate, than low-speed integrated detectors. Acquiring detailed knowledge of the high-speed performance of electro-optical devices without integrated monitoring high-speed photodetectors will also benefit integrated photonics technology by improving yield and driving down costs.

The technology disclosed can be implemented in some embodiments to obtain information about the operational characteristics of the tested devices, which can be used to perform additional fabrication steps on the wafer. Such processing steps may be difficult, or impossible, if a die were to be separated from the wafer for high-speed testing.

The technology disclosed can be implemented in some embodiments to test electro-optic devices at very low optical power, which may benefit the study of small or delicate electro-optical devices which may be damaged, or the device behavior altered, at higher levels of optical power. For example, increasing optical power levels in silicon photonic devices, particularly resonant modulators and switches, can lead to two photon absorption and free-carrier generation, leading to a different, and generally worse, device behavior than at lower optical power levels.

In some implementations of the disclosed technology, an apparatus for testing an electro-optic device disposed on a wafer includes an optical source to generate light, a first light transmission structure to route the light into the electro-optic device through a first guide segment structured arranged on the wafer and to guide optical waves and optically couplable to the electro-optic device, an electrical probe to apply one or more electrical modulation signals to the electro-optic device to generate modulated light by modulating the light routed into the electro-optic device, a second light transmission structure to collect at least part of the modulated light from a second guide segment arranged on the wafer and structured to guide optical waves and optically couplable to the electro-optic device, a detector to generate an electrical output signal corresponding to the collected light by detecting photons in the collected light, and a signal processing device to determine times at which photons in the collected light are detected by processing the electrical output signal.

In some implementations of the disclosed technology, a test device for testing one or more electro-optic devices disposed on a wafer includes a first guide segment structure on the wafter configured to receive input light from a first light transmission structure and to route the received light to at least one of the electro-optic devices, and a second guide segment structure positioned on the wafer to receive modulated light output from the at least one of the electro-optic devices, wherein the electro-optic device is operable to produce the modulated light in response to receiving an electrical modulation signal, the first guide segment is configured to receive the input light from an external light source, and the second guide segment is configured to allow at least part of the modulated light received therein to be collected by an external detector.

In some implementations of the disclosed technology, a method for testing an electro-optic device includes routing light generated by an optical source into the electro-optic device through a first guide segment arranged on the wafer and structured to guide optical waves and optically couplable to the electro-optic device, applying one or more electrical modulation signals to the electro-optic device to generate modulated light by modulating the light routed into the electro-optic device, collecting at least part of the modulated light from a second guide segment arranged on the wafer and structured to guide optical waves and optically couplable to the electro-optic device, generating an electrical output signal corresponding to the collected light by detecting photons in the collected light, and processing the electrical output signal to determine times at which the photons in the collected light are detected.

In some implementations of the disclosed technology, an apparatus for testing an electro-optic device includes means responsive to illumination which result in guiding a portion of the illumination to the electro-optic device, wherein there are no structures intended for coupling to external light within the region of illumination; means for applying at least one of a plurality of known electronic signals to the electro-optic device; means responsive to imperfect confinement of light after modulation by the electro-optic device which result in collecting at least some of the said modulated light; means for detecting the collected light using at least one single-photon detector, resulting in the generation of single-photon detection events that can be recorded; means for recording the times of detection of the single-photon detection events; means for generating a histogram of the recorded times of detection of the ensemble of the single-photon detection events; and means for identifying the one or plurality of subsets of the histogrammed detection events which represent the response of the electro-optic device to the one or plurality of electronic signals.

In some implementations of the disclosed technology, a method of testing an electro-optic device in the presence of background light includes: generating a first histogram of the recorded times of detection as described above; generating a second histogram of the recorded times of detection with either the optical illumination or optical collection, or both, intentionally misaligned from their positions used in generating the first histogram; and subtracting the second histogram from the first histogram, thus generating a third histogram which represents the response of the electro-optic device with a reduced dependence on background light.

The above and other aspects and implementations of the disclosed technology are described in more detail in the drawings, the description and the claims.

### BRIEF DESCRIPTION OF THE DRAWINGS

FIG. 1 illustrates an integrated electro-optic device under test and an apparatus for testing the integrated electro-optic device and a method of measuring electro-optic properties of the integrated electro-optic device, which is part of a photonic circuit fabricated on a wafer.

FIGS. 2A-2B show graphical representations of an output signal of the apparatus when fibers of the apparatus are correctly positioned over waveguides that guide light to or from the integrated photonic device under test (FIG. 2A), and when the fibers are not positioned correctly (FIG. 2B).

FIGS. 3A-3B show graphical representations of the measurement of optical waveforms generated by a modulator device driven by a non-return-to-zero binary waveform at a signaling rate of 5 gigabits per second, as acquired using a conventional method (FIG. 3A) and using the method implemented based on some embodiments of the disclosed technology (FIG. 3B).

FIG. 4A shows an example method of collecting weakly waveguide-coupled and -scattered light after modulation by an integrated Mach-Zehnder modulator (MZM) device under test (DUT) which is driven by RF test patterns. FIG. 4B is an example histogram showing the test pattern above the background light. FIG. 4C shows an example of a signal-to-noise ratio calculated from the histogram that can identify alignment rapidly, while the RF probe applies various test patterns to the DUT.

FIG. 5A shows a pattern obtained when driving a low-Vπ silicon photonic MZM at 10 Gbit·s⁻¹ close to its known limit, where an oscilloscope is used to capture an NRZ-encoded pattern, at −6 dBm average power at the receiver front-end. FIG. 5B shows the same pattern is detected using the scattering-based scheme as shown in FIG. 4A. FIG. 5C shows a magnified view of a short section of FIGS. 5A and 5B.

FIG. 6 shows an example of optical spectrum analysis.

FIG. 7 shows an example apparatus for testing an electro-optic device based on some embodiments of the disclosed technology.

FIG. 8 shows an example method of measuring electro-optic properties of an electro-optic device based on some embodiments of the disclosed technology.

### DETAILED DESCRIPTION

In certain electro-optic devices, the propagation of light can be controlled by applying an electrical waveform. Such devices are used in the fields of optical signal processing and optical communications. Examples of such devices are electro-optic modulators and electro-optic switches. Examples of electro-optic modulators include Mach-Zehnder, microring and electro-absorption modulators. In some cases, several modulator or switch devices may be manufactured using a single common material, which may be called a wafer or a substrate. The speed of modulator or switch devices may sometimes exceed ten million modulation or switching operations per second, and such devices may be called high-speed devices. A photonic circuit may refer to an assembly of one or more components, some of which may be electro-optic modulator or switch devices, connected using waveguides.

The disclosed technology can be implemented in some embodiments to provide an apparatus and method for testing or characterizing one or more electro-optic devices such as modulators and switches without separating them from a photonic circuit or a wafer.

Optical coupling structures intended for efficiently coupling light from regions that are external to the circuit may be omitted from the design. Examples of such optical coupling structures that can assist in characterizing electro-optic devices include grating couplers, directional couplers, angle-etched waveguides for re-directing the light path, or waveguide tapers which expand the mode size to promote interactions with structures or devices outside the waveguide.

In some implementations, an efficient optical coupler refers to an optical coupling structure which can couple a fraction of external light into a guided mode of the waveguide, or from the guided mode of one waveguide to that of another, which is greater than 1% (−20 dB).

Incorporating intentionally-defined efficient coupling structures on each high-speed device in a photon circuit is cumbersome, and susceptible to the accumulation of optical loss, feedback, noise, instability, and other imperfections. Very weak amounts of light may be collected by flood-illuminating a device and collecting scattered light from it; typical coupling efficiencies may be 0.01% (−40 dB) or less, resulting in a detected average power of about −40 dBm for an input power of 1 milliwatts. However, detection of high-speed modulation or switching, with bandwidth exceeding one gigahertz, as a representative example, requires a much higher level of optical power according to conventional schemes of photodetection, typically around −15 dBm or greater. Increasing the input power may cause damage, or alter the device behavior through impairments such as bias point shifting, two-photon absorption and free-carrier generation.

In some example implementations, integrated photodetectors, along with certain reconfigurable optical structures such as optical directional couplers, may be included in optical circuits near high-speed modulators or switches to facilitate measurement of their properties. The inclusion of photodetectors and inbuilt test circuitry usually requires permanent modifications to the structure of the photonic circuit, and usually requires the inclusion of additional structures or devices in the photonic circuit other than the electro-optic device itself, potentially raising the cost and complexity of fabrication. Usually, photodetectors require adequate amounts of light, typically tens of microwatts or more of optical power, to be able to measure the high-speed or high-frequency modulation. The diversion of significant amounts of light in the circuit to the integrated photodetector may also alter the operating condition of other parts of a larger photonic circuit.

In some example implementations, a method of testing or measuring the performance of electro-optic devices can be performed without optical readout based on monitoring the electronic conductivity of a material which guides light. This approach requires permanent modifications to the structure of the photonic circuit, and the inclusion of additional structures in the photonic circuit, potentially raising the cost and complexity of fabrication. In addition, this approach is based on an inefficient photo-detection scheme and is limited to relatively slow speeds (typically less than 1 megahertz) and does not test high-speed electro-optic devices.

In some example implementations, a method of testing photonic devices that lack coupling structures can be performed by using fiber probes with gratings fabricated on the fiber end facet, which enhance the collection of light that may be scattered or radiated from the device. However, this approach does not extend to the measurement of high-speed devices.

The lack of intentionally-defined optical coupling structures may result in the optical signal that is collected for such detection being very weak in power, perhaps even below the fundamental limits of detectable power associated with conventional high-speed photodetectors supporting the bandwidth necessary for the high speed operation of the device. As a specific example, the modulated optical waveform generated by a high-speed electro-optic modulator driven by signals with a data bandwidth of 25 GHz may not be detectable by a conventional optical sampling oscilloscope, even with extensive averaging, if the detected optical power is less than P=2·h·(c/λ)·B=−50 dBm for Nyquist bandwidth B=50 GHz (twice the data bandwidth), where h is Planck's constant, c is the speed of light and λ is the optical wavelength taken to be 1.55 microns. It is not obvious how such high-bandwidth electro-optic devices may be tested and characterized if the collected power is far below −50 dBm.

The disclosed technology can be implemented in some embodiments to provide a method and apparatus for characterizing high-speed electro-optic devices without intentionally-defined photonic structures or integrated photodetectors.

The disclosed technology can also be implemented in some embodiments to provide a method and apparatus for testing a plurality of devices simultaneously.

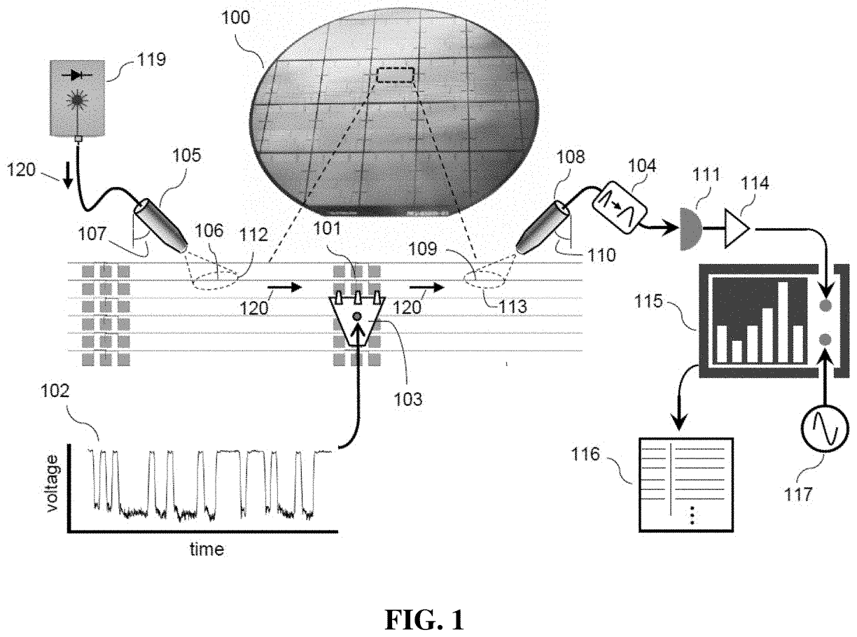

FIG. 1 illustrates an integrated electro-optic (or photonic) device under test and an apparatus for testing the integrated electro-optic device and a method of measuring electro-optic properties of the integrated photonic device, which is part of a photonic circuit fabricated on a wafer.

As shown in FIG. 1, an electro-optic (or photonic) device 101 is located on a wafer or substrate 100 to measure properties of the electro-optic device 101. In some implementations, examples of the electro-optic device 101 include electro-optic modulator devices and electro-optic switch devices. An electrical probe 103 is used as a means for applying one or a plurality of electronic modulation signals 102 to the electro-optic device 101.

The electro-optic device 101 may include one or more optical waveguides. In some implementations, the electro-optic device 101 includes a plurality of optical waveguides that extends between different electro-optic devices 101 located on a wafer or substrate 100. In one example, an optical waveguide extends toward an electro-optic device 101 under test to route light into the electro-optic device 101, and another waveguide extends away from the electro-optic device 101 to route light out of the electro-optic device 101. As shown in FIG. 1, a first waveguide or waveguide segment 106 structured to guide optical waves and optically couplable to the electro-optic device 101 is used as a means of routing light into the device 101 and a second waveguide or waveguide segment 109 structured to guide optical waves and optically couplable to the electro-optic device 101 is used as a means of routing light out of electro-optic device 101, and the light is directed in a direction 120 in which the first and second waveguides extend. In one example, these waveguides do not launch or collect light to, or from, the region above or below the plane of the electro-optic device 101. In other implementations, an optical waveguide extending in one direction is optically coupled with an electro-optic device 101 under test to route light into and out of the electro-optic device 101.

In some implementations, the apparatus for testing the integrated electro-optic device may include a light transmission structure such as a first fiber 105. In one example, the first fiber 105 is positioned above the first waveguide 106 at a first angle 107 to the vertical. The first fiber 105 is used as the means of illuminating the first waveguide 106 with light from an optical source 119 such as a laser or light-emitting diode.

In some implementations, the apparatus for testing the integrated electro-optic device may include another light transmission structure such as a second fiber 108. In one example, the second fiber 108 is positioned above a second waveguide 109, at a second angle 110 to the vertical. The second fiber 108 is used as the means of collecting the scattered light from a segment of the second waveguide 109 located after the electro-optic device 101 for the purpose of transporting the collected light to one or more single-photon detectors 111. The cause of scattering may be unintended roughness of the surface or side walls of a waveguide, which is typically present at the nanometer scale due to fabrication imperfections. Certain types of optical structures which cause discontinuities in a waveguide may also cause scattering, such as waveguide splitters or couplers. Alternatively, the light collected by the second fiber 108 may include photons lost to radiation by bends or constrictions in a waveguide.

In one example, the first and second angles 107 and 110 are identical. In another example, the first angle 107 is different from the second angle 110. In some implementations, the first and second angles 107 and 110 may be determined through experimentation. The distance of either the first fiber 105 or the second fiber 108 from the top surface of a waveguide may be varied individually to vary the spot sizes of the illumination pattern of the fiber at the plane of the waveguide 112 and 113. The sizes and shapes of patterns 112 and 113 may differ. In some implementations, the shape of the illumination patterns of the fibers may not match those of any guided mode of the waveguides, and because of poor mode matching, the fraction of light that is coupled into a guided mode of the waveguide 106 from the first fiber 105 is small and so also is the fraction of scattered light from a guided mode of the waveguide 109 after modulation which is collected by a collection fiber such as the second fiber 108. In some example implementations, a typical value of either coupling coefficient may be assumed to be 0.01%, but smaller or larger values may also be considered. The value of the coupling coefficient is not required to be known in performing the method of measuring the electro-optic properties based on some embodiments of the disclosed technology.

In some implementations, the apparatus for testing the integrated electro-optic device may include at least one of a wavelength shifting device 104, a detector 111, or an amplifier 114 (e.g., electronic amplifier), which can arranged between the second fiber 108 and a signal processing device configured to generate an output signal that represents electro-optic properties of the integrated electro-optic device under test. In some implementations, the detector 111 can be used to detect the light that is sent from the second fiber 108 to the detector 111. In one example, the detector 111 may include a single-photon detector. The amplifier 114 may be inserted before the detector 111 for the purposes of stretching the optical waveform in time before detection. In one example, the amplifier 114 may operate on the principles of dispersive or nonlinear methods of optical time-stretching. In some implementations, the wavelength shifting device 114 may be inserted before the detector 111 for the purposes of shifting the wavelength of the collected light before detection. In one example, the wavelength shifting device 114 may operate on the principles of nonlinear optics such as second harmonic generation, optical difference frequency generation, or parametric wavelength conversion. The output of the detector 111 is an electronic signal amplified by the amplifier 114. The output of the amplifier 114 may be processed using analog or digital signal processing by a signal processing device 115 to obtain an output signal 116. Examples of the output signal 116 may include an analog waveform, or a list of digital values recorded at various times (e.g., time-stamping). Examples of the signal processing device 115 include a time-to-digital converter (TDC), time-to-amplitude converter (TAC), time-correlated single-photon counter (TCPSC), or oscilloscope. In some implementations, a reference signal 117 may be provided to, or internally generated by, the signal processing device 115 to serve as a clock. The output signal 116 may be observed graphically or stored for subsequent analysis, for example, on a computer.

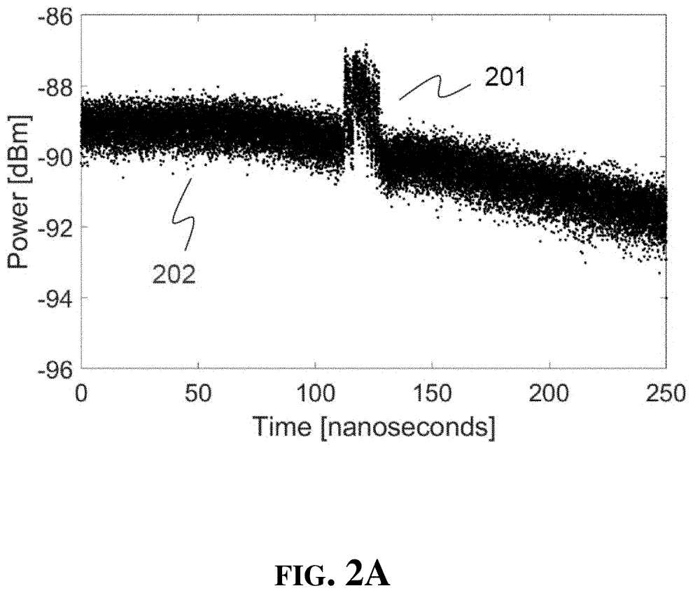

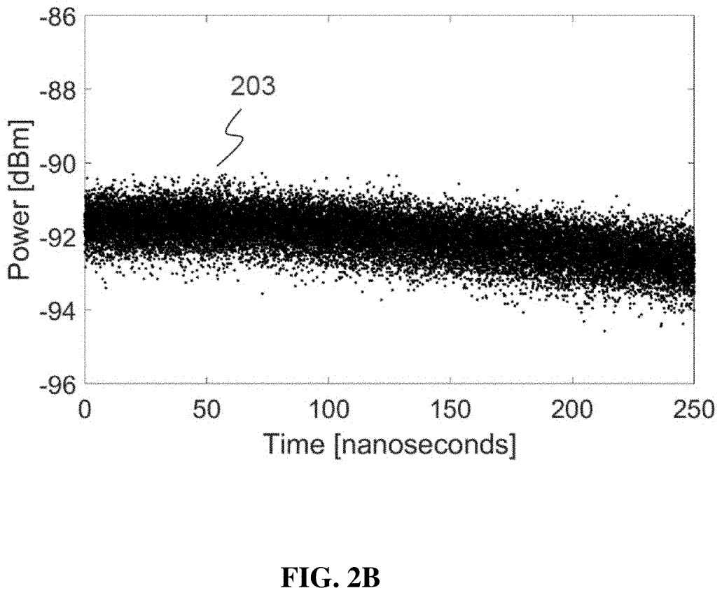

FIGS. 2A-2B show graphical representations of an output signal of the apparatus when fibers of the apparatus are correctly positioned over waveguides that guide light to or from the integrated photonic device under test (FIG. 2A), and when the fibers are not positioned correctly (FIG. 2B).

In some implementations, the signal processing for demodulation that may be performed to obtain the output 116 signal is a time correlated single-photon counting. This technique is based on calculating a histogram of the start-stop time difference between each photon detection event and a reference signal. The optical power of the light incident on the waveguide 106 or incident on the detector 111 is varied so that, on average, less than one detection event is performed per clock cycle. Under such circumstances, the detection events at the detector 111 follow Poisson statistics to a good approximation. The signal processing device 115 measures and records the time at which each photon is detected. The time difference of each detection event to the next clock cycle or pulse, Δtₙ (n=1, 2, 3, . . . enumerates the detected photons) is calculated. The histogram of Δtₙ may be output as the output signal 116. Such a histogram is typically updated as more photons are measured and may be viewed on the display screen of the signal processing device 115, if one is provided, similar to that of a conventional oscilloscope. However, the histogram may be calculated using off-line signal processing, if the output signal 116 simply consists of the recorded times of each photodetection event. Examples of a graphical representation of the data present in the output signal 116 are shown in FIGS. 2A and 2B. Such signals contain useful information about the electro-optic characteristics of the electro-optic device 101.

The disclosed technology can be implemented in some embodiments to provide a method of signal processing that may be used during or after generation of the output signal 116, to help in identification and exclusion of the events which arise from collection of unmodulated light by a fiber (e.g., second fiber 108). Some possible causes of such detection events are scattering of light around the electro-optic device 101 rather than transmission through it, or reflection of light that is input from fiber 105 by the substrate or other layers, and somehow being coupled into the second fiber 108 without propagating as a guided mode through the electro-optic device 101. Such unmodulated light will typically cause a broad, nearly-flat distribution of start-stop events shown as feature 203 in FIG. 2B. This is because attenuated un-modulated laser light, detected one photon at a time, results in nearly uniform and identically-distributed inter-arrival times. Once the first and second fibers 105 and 108 are correctly positioned such that some photons couple into and out of the guided mode of the electro-optic device 101 before reaching the collection fiber 108 and subsequently being detected by the detector 111, a distinct signal 201 is evident above the background 202 and may be distinguished from it using additional signal processing. Typically, the level of the background 202 is slightly higher than that of waveform 203, as is shown in FIGS. 2A-2B, but both background traces are usually broad and almost flat, compared with the distinct signal 201, which is narrow and sharply defined.

The disclosed technology can be implemented in some embodiments to provide a method of characterizing the electro-optic behavior of the electro-optic device 101 based on comparing the distinct signal 201, which is similar to what a conventional sampling oscilloscope displays, with the modulation signal 102. Examples of such comparative study include an analysis of the roll-off of frequency response, from which important device parameters such as the 3-dB modulation bandwidth of an electro-optic device modulator or switch can be determined.

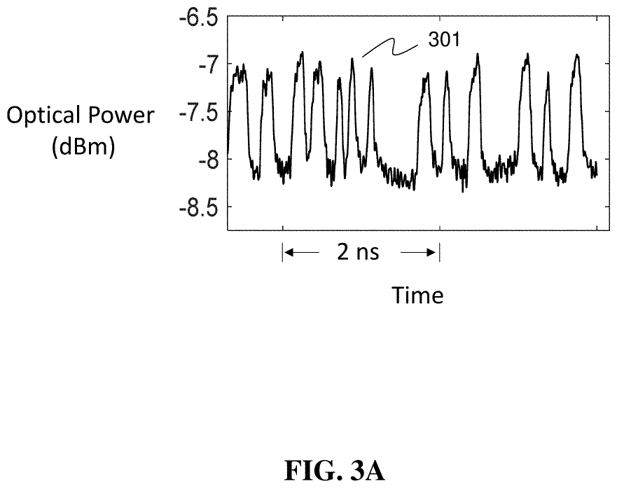

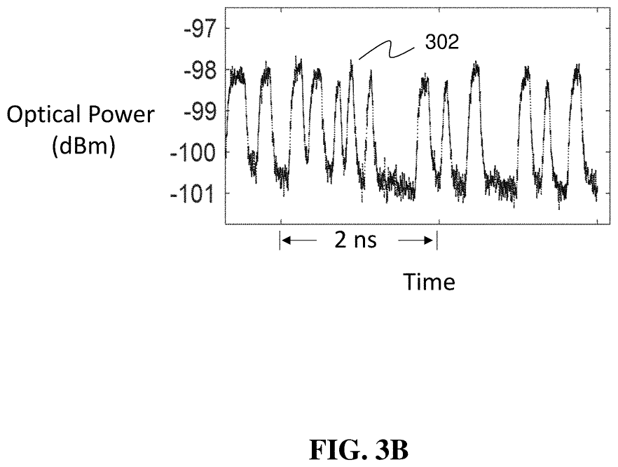

FIGS. 3A-3B show graphical representations of the measurement of optical waveforms generated by a modulator device driven by a non-return-to-zero binary waveform at a signaling rate of 5 gigabits per second, as acquired using a conventional method (FIG. 3A) and using the method implemented based on some embodiments of the disclosed technology (FIG. 3B).

Referring to FIGS. 3A-3B, the method of characterizing the electro-optic behavior of an electro-optic device based on some embodiments can be used to measure the electro-optic behavior of a silicon photonic Mach Zehnder modulator. In some implementations, a microchip under test may include both feeder waveguides (e.g., first and second waveguides 106 and 109 in FIG. 1) along certain portions of the microchip on which the modulator is fabricated as part of a photonic circuit. In some implementations, the microchip under test may also include waveguide-fiber edge couplers at the periphery of the microchip for purposes of comparison with a conventional measurement technique. The feeder waveguide allows for the measurement scheme as depicted in FIG. 1 to be implemented, for which a portion of the resulting output signal 116 is shown graphically as waveform 302 in FIG. 3B. The edge couplers allow for a comparative conventional test measurement using edge-aligned fibers that launch and collect light directly into or from the waveguide facets, with much higher coupling efficiency than achievable using the scheme shown in FIG. 1. The output of an optical sampling oscilloscope is shown as waveform 301 in FIG. 3A. In both cases, the modulation pattern applied as the modulation signal 102 is a binary data sequence using the non-return-to-zero (NRZ) signaling format at speeds of 5 Gigabits per second. The waveforms 301 and 302 are seen to be similar, even though waveform 301 is acquired at an average power level of about −7 dBm (0.2 milli-Watts) at the detector, whereas waveform 302 is acquired at an average power level of only about −98 dBm (160 femto-Watts) at the detector. This average optical power level achieved by the proposed measurement technique is many orders of magnitude below the minimum sensitivity of known oscilloscopes which support 5 GHz acquisition front-end bandwidth.

The similarity of the waveforms suggests that typical characteristics of a device under test using a conventional oscilloscope that generates waveform 301 may equivalently be studied using waveform 302. Some examples of such characteristics are extinction ratio, modulation amplitude, eye diagram, signal constellation, rise time, fall time, skew, jitter, and other distortions of the frequency components of the signal in amplitude and phase due to the characteristics or limitations of the electro-optical device.

The disclosed technology can be implemented in some embodiments to characterize an electro-optic device according to the principles discussed in this patent document. Referring back to FIG. 1, the device electro-optic 101 may be tested or characterized without being separated from the wafer 100. The electro-optic device 101 may be part of an assembly of multiple devices and may be tested or characterized without being separated from them. As long as the unmodulated light that is input to the electro-optic device 101 can still be modulated in accordance with the modulation signal 102, the probe 103 need not physically land on the wafer 100 or physically contact the electro-optic device 101.

In some implementations, multiple optical sources 119 may be used in place of a single source, in order to study the behavior of the electro-optic device 101 to two or more optical inputs. One example of such a test may be performed for optical or electro-optical crosstalk. In some implementations, the light generated by the optical source 119 may consist of a train of pulses, rather than a continuous-wave oscillation. If the pulse duration and repetition rate are in accordance with the sampling requirements associated with the bandwidth of the electro-optic response of device 101, the output signal 116 can be processed to obtain the characterization of the electro-optic device 101 without significant loss of information.

In some implementations, one or both the first and second fibers 105 and 108 may be replaced by one or a plurality of microscope objectives, optical components, such as lenses, prims, mirrors, fiber bundles or optical components which are generally used for illuminating and collecting light (e.g., scattered light from a target object). Both fibers 105 and 108 may be replaced by a single component such as a multi-mode fiber, a fiber bundle, or a single microscope objective or a single optical component such as a lens, which can illuminate a target object and simultaneously collect light from different angles.

In some implementations, both the first and second fibers 105 and 108, or their equivalents as described above, may optically address the electro-optic 101 directly, rather than waveguides that are visibly separated from the electro-optic device 101. Optical structures already present within the electro-optic device 101 may serve an equivalent purpose as waveguide segments 106 and 109 which are shown in FIG. 1. As an example, Mach-Zehnder electro-optic modulators contain segments of waveguides as part of the structure which may serve the same purpose as the waveguide segments 106 and 109.

In some implementations, the modulation signal 102 (e.g., modulating test signal), depicted in FIG. 1 as a voltage waveform as a function of time, may instead be a current waveform as a function of time, or any other electromagnetic waveform that applies power to the device 101 through probe 103 which results in modulation of light as indicated by 120.

In some implementations, the modulation signal 102 (e.g., modulating test signal) may include one or a plurality of sinusoidal oscillations or digital data patterns. In one example, the modulation signal 102 (e.g., modulating test signal) may include two or more electronic waveforms which are sent to different electrode structures which comprise the electro-optic device 101, such as often used for coherent modulator devices, or single-sideband modulation devices.

In some implementations, the output signal 201 may be studied in the frequency domain, for example, by performing a digital Fourier transform, in order to characterize the transfer function of the electro-optic device 101. Such studies carried out over a range of frequencies may be used to determine the modulation bandwidth or frequency roll-off of the electro-optic device 101, or other similar properties. The modulating signal 102 e.g., modulating test signal) may include more than one waveform; one example of such a test is that performed for two-tone intermodulation distortion.

In some implementations, the reference signal 117 may include a sinusoidal wave, or a sequence of pulses, or any periodic waveform from which the signal processing device 115, or the user who processes the output signal 116 externally, can determine a timing reference. The reference signal 117 may be obtained from an electronic clock or from the detection of other photons generated using the optical source 119 with a temporal correlation with the photons which are eventually received by the detector 111, but which are not sent through the apparatus shown in FIG. 1. In some implementations, the optical source 119 includes a short-pulse laser, of which some photons of each pulse are sent through the electro-optic device as previously described, and some of the other photons of each pulse are not sent through the electro-optic device but are instead detected using a low-jitter photo-detector to generate the reference signal 117.

In some implementations, multiple detectors 111 may be used in place of a single detector to improve the throughput of the apparatus. Some single-photon detectors may suffer from a “dead time” after each single-photon detection event, during which the detection efficiency is lower than its steady-state value. The use of additional detectors addressed by the light collected from a single device 101 may allow photons to be detected in the time slots when the first detector is unable to do so. Some single-photon detectors may be gated electronically to respond to light only during certain temporal intervals. Addressing multiple detectors by the light collected from a single device 101 may allow the ensemble of collected photons to be detected in the time slots when the first detector is unable to do so, thus improving throughput and utility of the apparatus for testing an electro-optic/photonic device.

In some implementations, a number-resolving multi-photon detector may be used in place of a single-photon detector 111. Signal processing may be used to identify those detection events which lead to Poisson arrival statistics. The output amplitude (current or voltage) of such a detector shows a one-to-one relationship with the number of photons that are detected, up to a certain number of photons (at least four in current implementations). In one example, the output of the detector 111 is an electronic signal amplified by the amplifier 114. The output of the detector 111 (or the amplifier 114) may be processed by a signal processing device 115 to obtain an output signal 116. In some implementations, signal processing, such as filtering the output by a range of acceptable current or voltage values, may be used to identify the single-photon detection events from the ensemble. Such usage allows the brightness or repetition rate of the illumination source to be increased, thus improving testing throughput, while ensuring that only single-photon detection events comprise the output signal 116.

In some implementations, the wavelength shifting device 104 may optionally include a wavelength splitter in order to separate frequency components of the signal collected by a fiber such as the second fiber 108. In another example, the wavelength shifting device 104 may optionally include a wavelength filter to optically filter the light collected by the second fiber 108. One application of such a filter is to reject background illumination, which may be present in the apparatus for purposes of alignment or viewing the device under test, or ambient lighting.

In some implementations, the wavelength shifting device 104 may include an optical device used in conjunction with coherent modulation to separate multiple quadratures of light into correspondingly multiple, separate output paths, which can each be detected as described for a single channel, followed by additional signal processing. As an example, the coherent modulation properties of device 101 can thus be determined by jointly processing the output signal 116 generated by two detectors 111, with a suitable optical component included in the amplifier 114, such as a delay-line interferometer.

In some implementations, additional signal processing may be performed on the signal 201 in order to reduce the imperfections of the measurement procedure or apparatus. Some examples of such corrections are time-base correction, and histogram bin counting nonlinearity correction, and jitter compensation. Calibration and compensation for the instrument response function are routinely performed in precision measurements. Additional signal processing may be performed on the signal 201 or the signal 302 to enhance the signal in known or predictable ways. Some examples are processing the signal with a matched filter, or a with a deconvolution filter based on the separately-measured characteristics of the measurement procedure or apparatus. The representation of the electro-optic device response is frequently shown as an eye diagram which is usually obtained by overlaying sweeps of different segments of a long waveform with reference to a clock signal.

In some implementations, parallel measurement of multiple parts of a wafer or circuit simultaneously may enable rapid characterization of many electro-optic devices, which may increase testing throughput and lower costs. The proposed measurement scheme may be operated in parallel, to characterize multiple electro-optical devices 101 across the wafer 100 at the same time. In a possible implementation of such a scheme, each electro-optic device uses light from one or a plurality of illumination sources, and is driven by a signal (e.g., 102), and the detections may be performed in parallel by one pixel, or a few pixels acting as one, of a multi-pixel single-photon detector device. Parallel measurement of multiple parts of a wafer or circuit simultaneously may enable rapid characterization of a large number of electro-optic devices, and increase testing throughput and lower costs.

In some implementations, the time of occurrence of each photon detection event may be recorded as the output signal 116, and additional signal processing, such as time-base correction or jitter compensation, may be performed in order to more accurately determine the start-stop time difference Δt of each detection event with respect to a reference signal.

In some implementations, the modulating test signal 102 may be a sinusoidal oscillation at a single frequency, f, rather than a digital data pattern. The output signal 201 may be studied in the frequency domain, for example, by performing a digital Fourier transform, in order to characterize the response of device 101 to the modulating frequency f. Such studies carried out over a range of values of f may be used to determine the modulation bandwidth or frequency roll-off of the device 101, or other similar properties.

In some implementations, the probe 103 may not physically land on the contact pads fabricated on the wafer 100, as long as the unmodulated light that is input to device 101 can still be modulated in accordance with the modulation signal 102.

In some implementations, the reference signal 117 may be obtained from the detection of other photons generated using the optical source 119 at the same time as the photons which are eventually received by detector 111, but which are not sent through the apparatus shown in FIG. 1. An example is the generation of a pair of time-correlated photons at the optical source 119, of which one photon is sent through the apparatus and the other is detected, using a separate detector not shown in FIG. 1, to generate the reference signal 117.

In some implementations, multiple signals 102 may be used in place of a single waveform, in order to study the behavior of the device 101 to two or more electronic signal inputs. In one example, such a test may be performed for two-tone intermodulation distortion. In another example, such a test may be performed on certain electro-optic modulators which accept two electronic waveforms for coherent modulation or for single-sideband modulation.

Full-Speed Testing of Silicon Photonic Electro-Optic Modulators from Picowatt-Level Scattered Light

The disclosed technology can be implemented in some embodiments to measure the full-speed performance of integrated modulators from ultraweak surface-coupled and scattered light. This can enable rapid characterization of unpackaged, high-speed wafer-scale integrated photonics without test ports or special fabrication.

The disclosed technology can also be implemented in some embodiments to provide a stand-off measurement of the full-speed operation of fully-fabricated photonic integrated Mach-Zehnder modulators (MZMs) without dedicated test ports, grating couplers, near-field coupling, or any special fabricated features. In some implementations, no grating couplers or special waveguide features are fabricated in the silicon photonic wafer, and the devices have about 4 μm of unplanarized, top-cladding oxides. MZMs are operated close to their limits, with limited extinction ratio, presenting practical challenges for low-noise, high-fidelity oscilloscopic capture. Our measurement technique successfully uses the ultra-weak (picowatts or less) optical power that is obtained when simply shining light from a milliwatt-class continuous-wave diode laser loosely onto the feeder waveguide, modulating the device electrodes with an RF test pattern and capturing the scattered, modulated light from a waveguide segment for detection. Eye diagrams are acquired and analyzed at optical power levels 80 dB lower than necessary for an optical sampling oscilloscope. Clear discrimination is obtained of the modulated test signal against the unmodulated background detection events, which can assist in rapid alignment and high-throughput testing. While final-stage testing and qualification will still be done after assembly, such measurements as shown here can help both early-stage high-speed diagnostics and guide further processing.

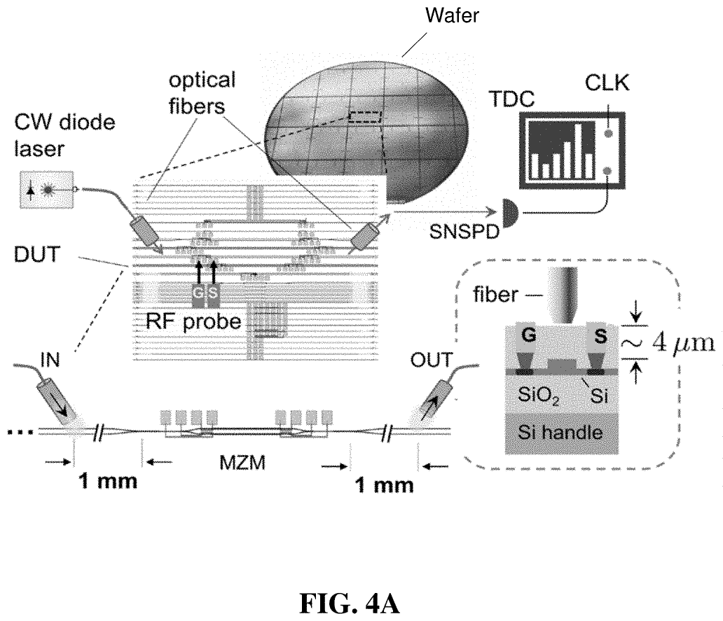

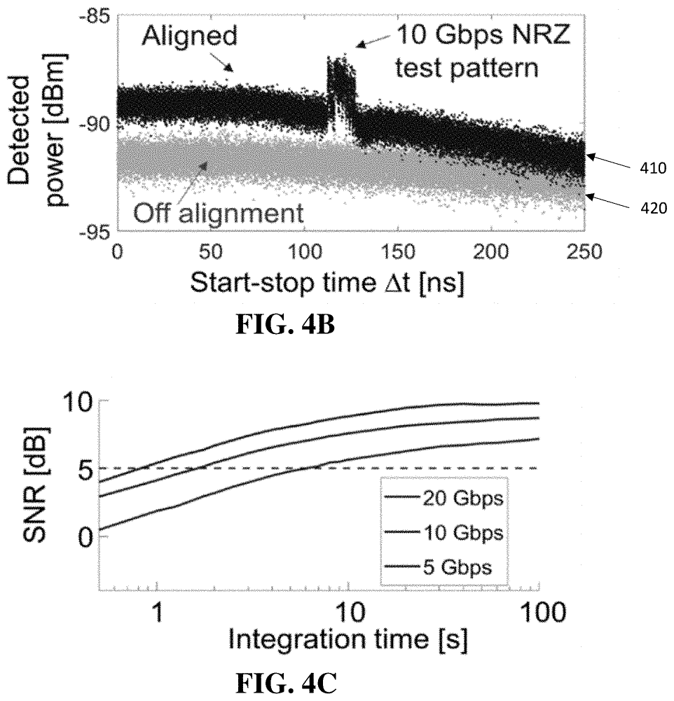

FIG. 4A shows an example method of collecting weakly waveguide-coupled and -scattered light after modulation by an integrated Mach-Zehnder modulator (MZM) device under test (DUT) which is driven by RF test patterns. Detection using a superconducting nanowire single-photon detector (SNSPD) is performed in the ultra-low power regime. Histograms of the start (photon detection) to stop (clock reference) time difference Δtₙ, performed, e.g., by a time-to-digital converter (TDC), reproduces the test RF waveform, over a few seconds. FIG. 4B is an example histogram showing the test pattern above the background light. FIG. 4C shows an example of a signal-to-noise ratio calculated from the histogram that can identify alignment (e.g., SNR^{(align)}>5 dB) rapidly, while the RF probe applies various test patterns to the DUT. The bandwidth limitations of this scheme are also studied.

In some implementations, low-Vπ depletion-mode p-n junction MZMs are fabricated in a foundry process on silicon-on-insulator (SOI) wafers. Each reticle contains several MZMs and other photonic devices. To permit comparison with conventional edge taper measurement, the device under test (DUT) is singulated from the wafer, but this is not required for routine operation. RF modulation signals generated by an arbitrary waveform generator are applied to the DUT using an SG probe landed on the electrical pads. As usual, the MZM has some lengths of input and output single-mode waveguides (e.g., 0.5 μm width) in the silicon plane. Two fibers are positioned above the chip, i.e., above the un-planarized upper SiO₂ cladding using micrometer-controlled positioning stages at an angle of 40° (input side) and 53° (output side) to the vertical, about 1 mm away from the MZM. Optimal angles depend on the structure, but once determined, remain constant when scanning the same design across a wafer. The input fiber is placed to illuminate a segment of waveguide before the MZM, and the other fiber is placed above a segment of waveguide after the MZM to collect scattered light for detection. A few different fibers available in the laboratory may be used, and results are shown when an SMF-28e fiber with a fiber Bragg grating near the cleaved tip is used on the illumination/input side (the recoated jacket is mechanically stripped), and a lensed, tapered fiber (spot size 2.5 μm) is used for the collection/output side. Continuous-wave light at about 1.55 μm wavelength from a fiber-coupled laser diode is used for measurement. The fraction of (unmodulated) light that is coupled into the guided mode of the waveguide from the first fiber is weak, as also is the fraction of scattered light from the waveguide after modulation that is coupled into the output fiber. From an input power of about 20 mW, about 5 pW of average power is coupled to the detector. Detection is performed using a fiber-coupled superconducting nanowire single-photon detector (SNSPD, e.g., detection efficiency ˜50% at 1550 nm) operated in a cold cryostat at 0.8K. Each photon detected by the SNSPD generated a “start” pulse for a time-to-digital converter (TDC) instrument. A periodic electrical clock (limited to 25 MHz) is sent to one of the electrical inputs of the TDC and generated the trigger of the “stop” signal. The histogram of the start-stop time difference Δtₙ, acquired repeatedly (n=1, 2, . . . enumerates the clock pulses) accurately reproduces the RF waveform that is applied to the DUT, as explained elsewhere. At the TDC's maximum clock rate (25 MHz), up to 10 million photons can be processed per second, since less than one detection event should occur per clock tick. There are 40,000, e.g., (25 MHz)⁻¹(1 ps)⁻¹, time bins accumulating at about 250 events per second, on average. Unmodulated light also finds its way into the output fiber; the start-stop histogram of such events forms a broad, nearly-flat background, with the modulated DUT response above this background.

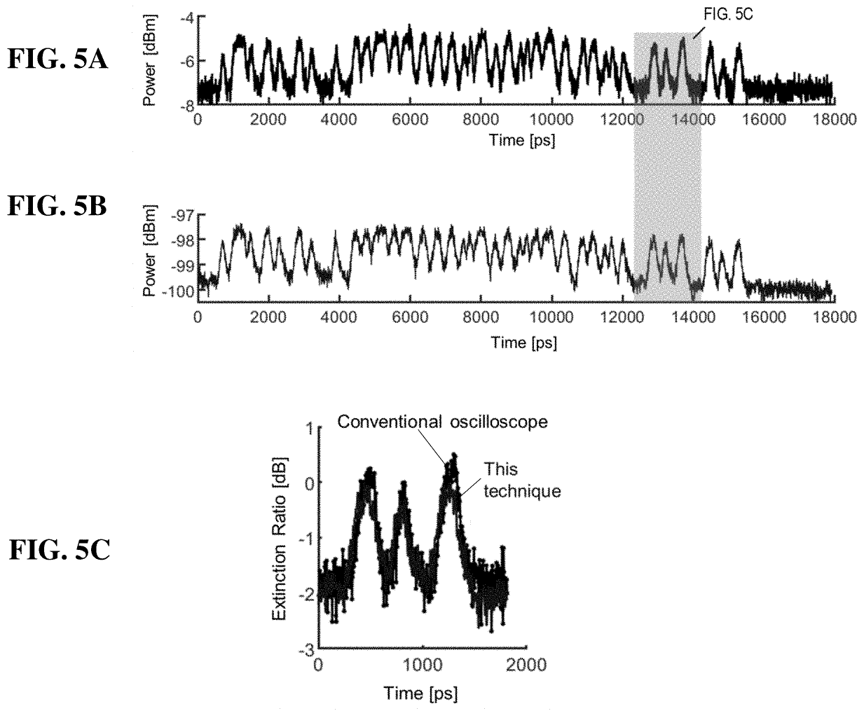

FIG. 5A shows a pattern obtained when driving a low-Vπ silicon photonic MZM at 10 Gbit·s⁻¹ close to its known limit, where an oscilloscope is used to capture an NRZ-encoded pattern, at −6 dBm average power at the receiver front-end. This measurement is performed using traditional edge coupling of waveguides to fibers. FIG. 5B shows the same pattern is detected using the scattering-based scheme as shown in FIG. 4A. FIG. 5C shows a magnified view of a short section of FIGS. 5A and 5B, showing the agreement, despite the >90 dB difference in detected optical power.

Rapid Alignment

In some implementations, fiber positioning above a device is performed coarsely by visual (camera) guidance, and more accurately by scanning the micropositioning stage when measuring an appropriately-defined signal-to-noise ratio (SNR) metric. When the input and output fibers do not interrogate the waveguides of the RF-modulated MZM, the start-stop histogram{Δtₙ} of collected photons is more or less flat and featureless (see 420 in FIG. 4B). This is because attenuated unmodulated laser light has Poisson statistics, with uniform and identically-distributed inter-arrival times. Once the chip is positioned such that some light couples into and out of the guided mode of the MZM, the test pattern is evident above the background (see 410 in FIG. 4B). As a guide to alignment, SNR^{(align)} is defined as the ratio of the mean signal trace over twice the standard deviation of the background trace. FIG. 4C shows SNR for various acquisition times, with 10 ps TDC bin width and different NRZ modulation speeds applied to the DUT. In order to achieve SNR>5 dB, acquisition over just a few seconds is seen to be adequate. Thus, a DUT can be rapidly placed under the fibers by scanning its position for optimal SNR^{(align)}.

High-Frequency Digital and Analog Pattern Capture

Referring to FIG. 5B, the waveform is acquired when the MZM is modulated with an NRZ bit sequence. Since the modulators on this wafer lacked RF coplanar transmission lines, they are bandwidth limited to about 10 Gbit·s⁻¹ and thus provide a useful test of silicon MZM performance close to the limits with limited extinction ratio and other imperfections. The detected average power is 0.16 pW, the acquisition time is 30 seconds, and the acquired histogram is digitally low-pass filtered with a 50 GHz cutoff. For accurate comparison, FIG. 5A also shows the same pattern captured in a conventional way on a singulated chip using waveguide-fiber edge-couplers, and detected using an optical oscilloscope. The magnified view of a few bits (see FIG. 5C) shows the agreement of the waveforms, despite the greater-than-90 dB difference in the power level and low extinction ratio (ER) of the MZM.

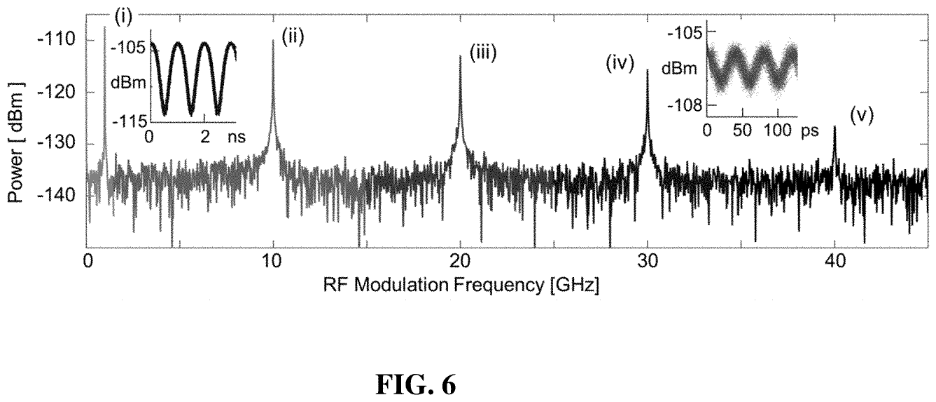

FIG. 6 shows an example of optical spectrum analysis. Measurements of RF sinusoidal modulation of a test MZM (with edge couplers) are acquired over 30 s using start-stop detection at ultra-low optical power. Each trace is Fourier transformed, resulting in a spectral resolution of 25 MHz. Shown is a composite plot of the main resonances (excluding harmonics) at RF frequencies of (i) 1 GHz (with a short segment of the acquired time-domain 1 GHz modulated optical waveform shown in the inset), (ii) 10 GHz, (iii) 20 GHz, (iv) 30 GHz (with time-domain inset), and (v) 40 GHz.

Since the random selection of single photons from attenuated laser light (with Poisson statistics) itself results in a Poisson process, the entire test waveform is fair-sampled by the single photon detector, and the histogram faithfully reproduces the test pattern. In contrast to traditional oscilloscopy, scattered light can be rejected in data processing, since it leads to a broad, feature-less distribution of start-stop histogram events, qualitatively different from the test pattern. The key advantage of this technique is that modulation can be quickly detected at five orders of magnitude lower optical power than the so-called quantum limit, P=2·h·(c/λ)·B=−50 dBm for Nyquist bandwidth B=50 GHz. The measurement method described here does not require detection and digitization bandwidths at twice the highest test modulation frequency, which, for high-speed testing, usually requires challenging scan synchronization and calibration methods, and costly cables. Here, the detector requires only simple RF cables, connectors and amplifiers that support only modest RF bandwidth (<1.5 GHz).

FIG. 6 shows the application of the instrumentation based on some embodiments of the disclosed technology as a spectrum analyzer, obtained by taking the Fourier transform of the time trace. A reference MZM on a chip with waveguide-fiber edge couplers is used to capture test sine frequencies past 40 GHz (approximately, the inverse of the measured SNSPD timing jitter, 24 ps) with 30 s acquisition time. Even with reduced ER at higher frequencies, electro-optic modulation can be identified up to 40 GHz in the current apparatus at ultralow optical power levels. Certain SNSPDs can support 100 GHz bandwidth pattern capture, but with low detection efficiency, making them unsuitable at present for testing large numbers of unpackaged, unstabilized modulators rapidly, compared to what the detector implemented based on some embodiments of the disclosed technology is able to achieve.

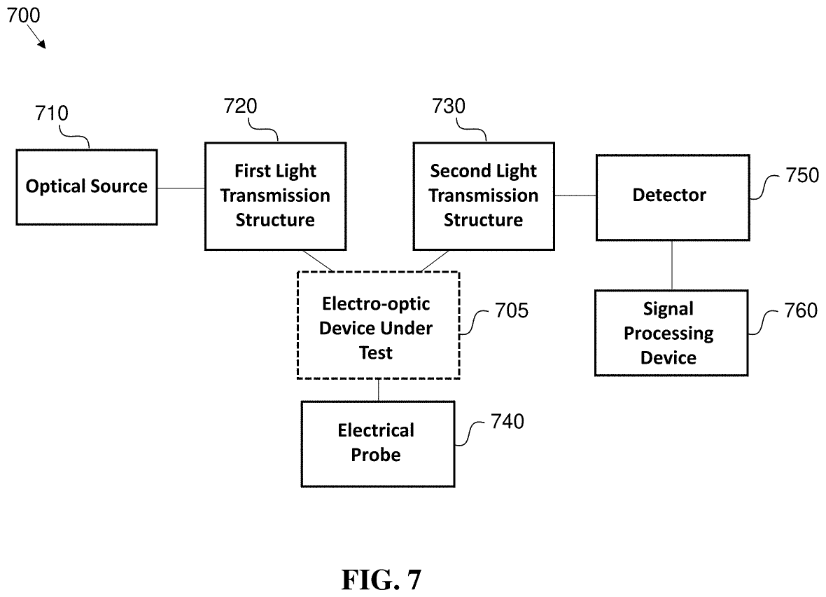

FIG. 7 shows an example apparatus for testing an electro-optic device based on some embodiments of the disclosed technology.

Referring to FIG. 7, an apparatus 700 for testing an electro-optic device 705 disposed on a wafer includes an optical source 710 to generate light, a first light transmission structure 720 to route the light into the electro-optic device 705 through a first guide segment arranged on the wafer and structured to guide optical waves and optically couplable to the electro-optic device 705, an electrical probe 740 to apply one or more electrical modulation signals to the electro-optic device 705 to generate modulated light by modulating the light routed into the electro-optic device 705, a second light transmission structure 730 to collect at least part of the modulated light from a second guide segment arranged on the wafer and structured to guide optical waves and optically couplable to the electro-optic device 705, a detector 750 to generate an electrical output signal corresponding to the collected light by detecting each photon in the collected light, and a signal processing device 760 to determine times at which each photon in the collected light is detected by processing the electrical output signal.

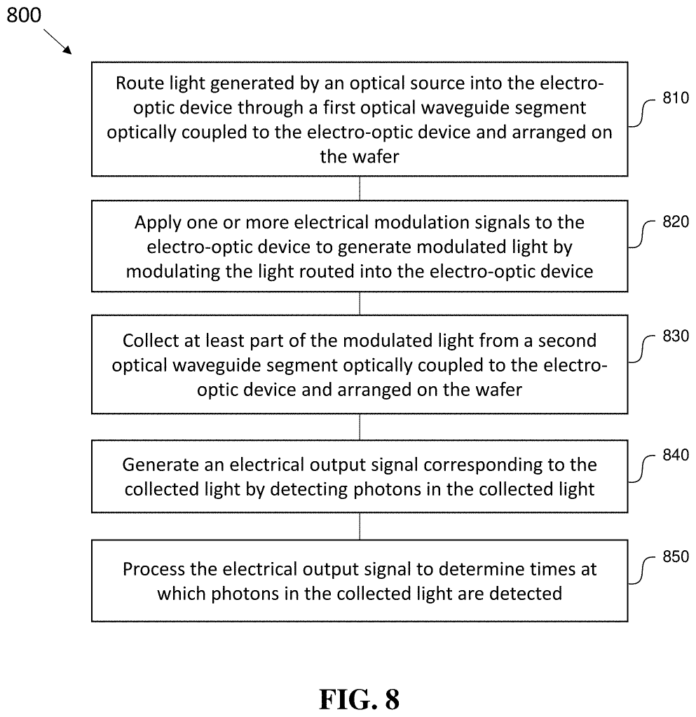

FIG. 8 shows an example method of measuring electro-optic properties of an electro-optic device based on some embodiments of the disclosed technology.

Referring to FIG. 8, a method 800 of measuring electro-optic properties of an electro-optic device includes, at 810, routing light generated by an optical source into the electro-optic device through a first guide segment arranged on the wafer and structured to guide optical waves and optically couplable to the electro-optic device, at 820, applying one or more electrical modulation signals to the electro-optic device to generate modulated light by modulating the light routed into the electro-optic device, at 830, collecting at least part of the modulated light from a second guide segment arranged on the wafer and structured to guide optical waves and optically couplable to the electro-optic device, at 840, generating an electrical output signal corresponding to the collected light, and at 850, processing the electrical output signal to determine times at which each photon corresponding to the collected light is detected.

The disclosed technology can be implemented in some embodiments to provide full-speed measurements of integrated Mach-Zehnder modulators at extremely low (<5 picowatts) average optical power, with an acquisition time of a few tens of seconds. Unlike any other technique, such ultra-low power levels are adequate for testing at tens-of-GHz-bandwidth, and thus light is shined onto a feeder waveguide and scattered light is collected after the device under test (DUT). The disclosed technology can also be implemented in some embodiments to rapidly acquire detailed knowledge of the actual performance of each high-speed device in a wafer without access ports or test structures, and to do so at full operational speed will benefit integrated photonics technology by improving yield and driving down costs.

The disclosed technology can be implemented in some embodiments to provide a method for charactering the operation of an electro-optic device such as a modulator or a switch which is operated at high speed. Intentionally-defined optical coupling structures or integrated photodetectors are omitted from the electro-optic device, or circuit of which the device is a part. The device is characterized by illuminating a waveguide which guides light to the device; driving the device with an electronic waveform; collecting light from a region after the electro-optic device, such as scattered light from a waveguide; detecting the coupled light using a single-photon detector, and using signal processing to generate an output signal from which one can identify a subset of the detection events which represent the response of the electro-optic device to the signal which is used to drive the device. As a result, high-speed characterization of the device can be performed without optical coupling structures or integrated photodetectors, even though the average optical power levels of the detected light may be extremely weak.

An advantage of some embodiments of the disclosed technology is that it may enable testing high-speed modulator devices before singulation, separation from the wafer or photonic circuit, and/or packaging, which may be costly and time consuming. Rapidly acquiring detailed knowledge of the actual performance of each high-speed device in a wafer without access ports or test structures or integrated detectors, and to do so at full operational speed will benefit integrated photonics technology by improving yield and driving down costs.

Some photonic circuits include integrated photodetectors to monitor bias points, temperature drifts, polarization drifts, or other quasi-static or slowly-varying signals. Another advantage of some embodiments of the disclosed technology is that it may enable testing high-speed modulator devices without inclusion of integrated high-speed photodetectors, which are more costly to fabricate, or difficult to operate, than low-speed integrated detectors. Acquiring detailed knowledge of the high-speed performance of electro-optical devices without integrated monitoring high-speed photodetectors will also benefit integrated photonics technology by improving yield and driving down costs.

Another advantage of some embodiments of the disclosed technology is that it may be used to obtain information about the operational characteristics of the tested devices, which can be used to perform additional fabrication steps on the wafer. Such processing steps may be difficult, or impossible, if a die were to be separated from the wafer for high-speed testing.

Another advantage of some embodiments of the disclosed technology is that it may be used to test electro-optic devices at very low optical power, which may benefit the study of small or delicate electro-optical devices which may be damaged, or the device behavior altered, at higher levels of optical power. For example, increasing optical power levels in silicon photonic devices, particularly resonant modulators and switches, can lead to two photon absorption and free-carrier generation, leading to a different, and generally worse, device behavior than at lower optical power levels.

Therefore, various implementations of features of the disclosed technology can be made based on the above disclosure, including the examples listed below.

### Example 1

An apparatus for testing an electro-optic device comprising: means responsive to illumination which result in guiding a portion of the illumination to the electro-optic device, wherein there are no structures intended for coupling to external light within the region of illumination; means for applying at least one of a plurality of known electronic signals to the electro-optic device; means responsive to imperfect confinement of light after modulation by the electro-optic device which result in collecting at least some of the said modulated light; means for detecting the collected light using at least one single-photon detector, resulting in the generation of single-photon detection events that can be recorded; means for recording the times of detection of the single-photon detection events; means for generating a histogram of the recorded times of detection of the ensemble of the single-photon detection events; and means for identifying the one or plurality of subsets of the histogrammed detection events which represent the response of the electro-optic device to the one or plurality of electronic signals.

### Example 2

The apparatus as in Example 1, wherein the means responsive to imperfect confinement of light after modulation by the electro-optic device comprises one or a plurality of optical fibers, lenses, microscope objectives, prisms or mirrors.

### Example 3

The apparatus as in Example 1, wherein the light that is collected after modulation comprises scattered light from the roughness of at least one waveguide which does not contain structures intended for coupling to external light within the region from which the light is collected.

### Example 4

The apparatus as in Example 1, wherein the light that is collected after modulation comprises scattered light from at least one junction between dis-similar waveguides or between dis-similar waveguide components.

### Example 5

The apparatus as in Example 1 wherein the said collected light is converted to a different wavelength before detection.

### Example 6

The apparatus as in Example 5 wherein the wavelength conversion of light is accomplished by using a nonlinear optical method, such as sum frequency generation, difference frequency generation, or parametric wavelength conversion, or combinations thereof.

### Example 7

The apparatus as in Example 1 wherein both illumination and photon collection is performed using one-and-the same means, such as one-and-the-same optical component such as a fiber, lens, prism, microscope objective or mirror.

### Example 8

The apparatus as in Example 1 wherein a plurality of single-photon detectors is used to detect the collected photons to increase either the probability of detection or the rate of detection, or both.

### Example 9

The apparatus as in Example 1 wherein the collected photons are detected using number-resolving photon detectors from whose output the single-photon detection events can be post-selected.

### Example 10

The apparatus as in Example 1 wherein the histogramming of the recorded times of detection is based on a timing reference signal that is derived from a portion of the illumination.

### Example 11

The apparatus as in Example 1 wherein the histogramming of the recorded times of detection is based on a timing reference signal that is derived from an electronic clock signal.

### Example 12

The apparatus as in Example 1 wherein one or a plurality of optical attenuators are used before detection to ensure that only one photon arrives at each detector within a pre-determined time window.

### Example 13

The apparatus as in Example 1 wherein one or a plurality of optical filters are used before detection to reduce the likelihood of detection of light at undesirable wavelengths.

### Example 14

The apparatus as in Example 1 wherein the response of the electro-optic device is represented as an eye diagram.

### Example 15

The apparatus as in Example 1 for testing multiple electro-optic devices simultaneously, wherein one or a plurality of a set of orthogonally-coded electronic signals is used for each electro-optic device, such that the response of each device can be distinguished from the recorded photon detection events.

### Example 16

A method of testing an electro-optic device in the presence of background light, comprising: generating a first histogram of the recorded times of detection as described in Example 1; generating a second histogram of the recorded times of detection with either the optical illumination or optical collection, or both, intentionally misaligned from their positions used in generating the first histogram; and subtracting the second histogram from the first histogram, thus generating a third histogram which represents the response of the electro-optic device with a reduced dependence on background light.

### Example 17

A method of characterizing the behavior of electro-optic devices comprising: illuminating a waveguide which guides light to the electro-optic device, wherein the said waveguide does not contain structures intended for coupling to external light; applying a known electronic signal to the electro-optic device; collecting light from a region after the electro-optic device, such as scattered light from a waveguide that guides light away from the device, wherein the said waveguide does not contain any structures intended for coupling to external light; detecting the coupled light using a single-photon detector, and recording the time stamps of detection events; and processing the ensemble of time-stamped events, such as through histogramming and digital signal processing, to generate an output signal from which one can identify a subset of the detection events which represent the response of the electro-optic device to the known electronic signal.

### Example 18

A method of characterizing the behavior of electro-optic devices, wherein the device, or photonic circuit that it is a part of, does not contain an integrated photodetector, comprising: illuminating a waveguide which guides light to the electro-optic device, wherein the said waveguide does not contain structures intended for coupling to external light; applying a known electronic signal to the electro-optic device; collecting light from a region after the electro-optic device, such as scattered light from a waveguide that guides light away from the device, wherein the said waveguide does not contain any structures intended for coupling to external light; detecting the coupled light using a single-photon detector, and recording the time stamps of detection events; and processing the ensemble of time-stamped events, such as through histogramming and digital signal processing, to generate an output signal from which one can identify a subset of the detection events which represent the response of the electro-optic device to the known electronic signal.

### Example 19

A method as in Example 17 or in Example 18, used for characterizing the behavior of the electro-optic device based on analyses of the processed output signal and the known electronic signal applied to the electro-optic device.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the singular forms “a,” “an” and “the” are intended to include the plural forms as well, unless the context clearly indicates otherwise. Additionally, the use of “or” is intended to include “and/or,” unless the context clearly indicates otherwise.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. An apparatus for testing an electro-optic device disposed on a wafer, comprising:
a first light transmission structure to route light received from a light source into the electro-optic device through a first guide segment arranged on the wafer and structured to guide optical waves and optically couplable to the electro-optic device;
an electrical probe couplable to the electro-optic device and operable to apply one or more electrical modulation signals to the electro-optic device to generate modulated light by modulating the light routed into the electro-optic device;
a second light transmission structure positioned to collect at least part of the modulated light from a second guide segment arranged on the wafer and structured to guide optical waves and optically couplable to the electro-optic device;
an optical detector positioned external to the electro-optic device to receive the collected light from the second light transmission structure and to generate an electrical output signal corresponding to the light received thereon; and
a signal processing device positioned external to the electro-optic device and configured to process the electrical output signal and to determine times at which photons in the collected light are detected.

2. The apparatus of claim 1, wherein the first light transmission structure, the second light transmission structure and the electrical probe are external to both the wafer and the electro-optic device, and are not in physical contact with the wafer and the electro-optic device.

3. The apparatus of claim 1, wherein the optical detector is responsive to an imperfect confinement of the light after modulating the light routed into the electro-optic device.

4. The apparatus of claim 1, wherein the optical detector includes a single photon detector configured to detect single-photon detection events.

5. The apparatus of claim 4, wherein the signal processing device determines the times at which photons in the collected light are detected by: recording times of the single-photon detection events; generating a histogram of the recorded times corresponding to the single-photon detection events; and identifying one or more subsets of the histogram that represent a response of the electro-optic device to the one or more electrical modulation signals.

6. The apparatus of claim 5, wherein the histogram of the recorded times corresponding to the single-photon detection events is based on a timing reference signal that is derived from the light generated by the optical source or from an electronic clock signal.

7. The apparatus of claim 1, wherein the optical detector includes a plurality of single-photon detectors each configured to single-photon detection events.

8. The apparatus of claim 1, wherein the optical detector includes a number-resolving multi-photon detector configured to generate a plurality of single-photon detection events and select at least one of the single-photon detection events.

9. The apparatus of claim 1, wherein the first and second light transmission structures include at least one of optical fiber, lens, microscope objective, prism or mirror.

10. The apparatus of claim 1, wherein the at least part of the modulated light collected by the second light transmission structure includes scattered light from a rough portion of at least one of the first guide segment or the second guide segment or from at least one junction between the first guide segment and the second guide segment.

11. The apparatus of claim 1, further comprising a wavelength shifting device arranged between the second light transmission structure and the detector to convert the collected light to a different wavelength before detection by the detector.

12. The apparatus of claim 11, wherein each of the first and second light transmission structures is part of a single optical component, and wherein the single optical component includes at least one of fiber, lens, prism, microscope objective or mirror.

13. The apparatus of claim 1, further comprising one or more optical attenuators between the second light transmission structure and the detector to ensure that only one photon arrives at the detector within a pre-determined time window or reduce a likelihood of detection of light at undesirable wavelengths.

14. The apparatus of claim 1, wherein the signal processing device configured to test multiple electro-optic devices simultaneously by applying one or more sets of orthogonally-coded electronic signals to each electro-optic device, such that a response of each electro-optic device is distinguishable from other photon detection events.

15. A test device for testing one or more electro-optic devices disposed on a wafer, comprising:
a first guide segment structure on the wafter configured to receive input light from a first light transmission structure and to route the received light to at least one of the electro-optic devices; and
a second guide segment structure positioned on the wafer to receive modulated light output from the at least one of the electro-optic devices, wherein:
the electro-optic device is operable to produce the modulated light in response to receiving an electrical modulation signal,
the first guide segment is configured to receive the input light from an external light source,
the second guide segment is configured to allow at least part of the modulated light received therein to be collected by an external detector.

16. The apparatus of claim 15, wherein at least one of the first guide segment or the second guide segment includes a rough portion to generate scattered light from the rough portion.

17. The apparatus of claim 15, wherein the test device further comprises at least one junction between the first guide segment and the second guide segment to generate scattered light from the at least one junction.

18. A method for testing an electro-optic device, comprising:
routing light generated by an optical source into the electro-optic device through a first guide segment arranged on the wafer and structured to guide optical waves and optically couplable to the electro-optic device;
applying one or more electrical modulation signals to the electro-optic device to generate modulated light by modulating the light routed into the electro-optic device;
collecting at least part of the modulated light from a second guide segment arranged on the wafer and structured to guide optical waves and optically couplable to the electro-optic device;
generating an electrical output signal corresponding to the collected light by detecting photons in the collected light; and
processing the electrical output signal to determine times at which the photons in the collected light are detected.

19. The method of claim 18, wherein the electrical output signal is generated by detecting single-photon detection events.

20. The method of claim 19, wherein the processing of the electrical output signal includes:
recording times of the single-photon detection events;
generating a histogram of the recorded times corresponding to the single-photon detection events; and
identifying one or more subsets of the histogram that represent a response of the electro-optic device to the one or more electrical modulation signals.

21. The method of claim 18, wherein the testing of the electro-optic device is performed in the presence of background light.

22. The method of claim 21, wherein the processing of the electrical output signal includes:
generating a first histogram of recorded times of detection by placing a first light transmission structure at a first position to route the light generated by the optical source into the electro-optic device and by placing a second light transmission structure at a second position to collect at least part of the modulated light from the electro-optic device;
generating a second histogram of the recorded times of detection by changing at least one of the first position of the first light transmission structure or the second position of the second light transmission structure; and
subtracting the second histogram from the first histogram to generate a third histogram representing a response of the electro-optic device with a reduced dependence on the background light.

23. The method of claim 18, wherein the processing of the electrical output signal includes characterizing properties of the electro-optic device by comparing the processed electrical output signal with a reference signal.
